(19) United States
(12) Patent Application Publication
(10) Pub. No.: US 2023/0339399 A1
(43) Pub. Date: Oct. 26, 2023

(54) RETRACTABLE VEHICLE MIRROR SUPPORT DEVICE

(71) Applicant: Fritzner Marcelin, Gardner, MA (US)

(72) Inventor: Fritzner Marcelin, Gardner, MA (US)

(21) Appl. No.: 17/724,832

(22) Filed: Apr. 20, 2022

(51) Int. Cl. B60R 1/074

(52) U.S. Cl. CPC B60R 1/074

(57) ABSTRACT

A retractable vehicle mirror support device, including a first retractable arm disposed on at least a portion of a vehicle connector and connected to a vehicle mirror to move the vehicle mirror from extended away from the vehicle connector to retracted toward the vehicle connector in a first lateral direction, and a second retractable arm disposed on at least a portion of the vehicle connector and connected to the vehicle mirror to move the vehicle mirror from extended away from the vehicle connector to retracted toward the vehicle connector in the first lateral direction, such that the second retractable arm is separate and distanced away from the first retractable arm.

### BACKGROUND

### 1. Field

The present general inventive concept relates generally to a vehicle mirror, and particularly, to a retractable vehicle mirror support device.

### 2. Description of the Related Art

Most large vehicles, such as trucks, buses, and/or recreational vehicles (RV), have side mirrors with long extensions that are built for providing visual support when hauling a trailer. However, these side mirrors cannot be retracted and/or reduced in length.

The long extension of the side mirrors impacts available space, particularly in a parking area with limited size, such as a garage. For example, a two-car garage would only fit a single truck with the side mirrors having the long extension. Moreover, the side mirrors having the long extension are susceptible to collisions due to occupying more space, such as bicycle riders.

Therefore, there is a need for a retractable vehicle mirror support device that adjusts a length of a mirror on a vehicle to reduce an amount of necessary space occupied by the vehicle.

### SUMMARY

The present general inventive concept provides a retractable vehicle mirror support device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a retractable vehicle mirror support device, including a first retractable arm disposed on at least a portion of a vehicle connector and connected to a vehicle mirror to move the vehicle mirror from extended away from the vehicle connector to retracted toward the vehicle connector in a first lateral direction, and a second retractable arm disposed on at least a portion of the vehicle connector and connected to the vehicle mirror to move the vehicle mirror from extended away from the vehicle connector to retracted toward the vehicle connector in the first lateral direction, such that the second retractable arm is separate and distanced away from the first retractable arm.

The first retractable arm and the second retractable arm may each include a first section disposed on at least a portion of the vehicle connector, and a second section movably disposed on at least a portion of the first section to move from extended away from the first section to retracted within the first section in a first lateral direction.

The second section may move by at least one of folding, rotating angularly, rotating vertically, and rotating laterally.

The first retractable arm and the second retractable arm may each further include an extension rod disposed within at least a portion of the first section and the second section to facilitate movement of the second section with respect to the first section.

The retractable vehicle mirror support device may further include a motor movably disposed on at least a portion of the first retractable arm and the second retractable arm to move the first retractable arm and the second retractable arm in response to movement of the motor.

The motor may move the first retractable arm and the second retractable arm from extended to retracted in the first lateral direction, and the first retractable arm and the second retractable arm move from retracted to at least partially extended in a second lateral direction in response to an external application of force.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a retractable vehicle mirror support device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.
List of Components
Retractable Vehicle Mirror Support Device 100
First Retractable Arm 110
First Section 111
Second Section 112
First Extension Rod 113
Second Retractable Arm 120
First Section 121
Second Section 122
Second Extension Rod 123
Motor 130
Control Button 140

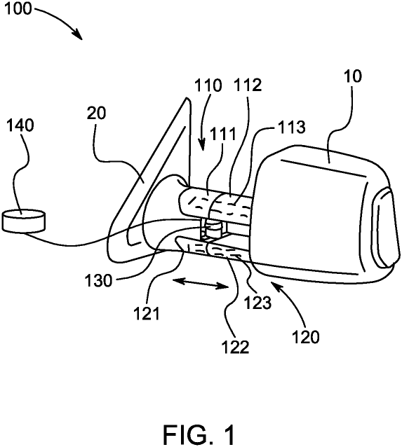

FIG. 1 illustrates a side perspective view of a retractable vehicle mirror support device 100, according to an exemplary embodiment of the present general inventive concept.

The retractable vehicle mirror support device 100 may be constructed from at least one of metal, plastic, wood, glass, and rubber, etc., but is not limited thereto.

The retractable vehicle mirror support device 100 may include a first retractable arm 110, a second retractable arm 120, a motor 130, and a control button 140, but is not limited thereto.

Referring to FIG. 1, the first retractable arm 110 and/or the second retractable arm 120 are illustrated to be separate components. However, the first retractable arm 110 and/or the second retractable arm 120 may be a singular, integral component, but is not limited thereto. In other words, the first retractable arm 110 and/or the second retractable arm 120 may lack a space (i.e., distance) therebetween, and be a single, solid, and/or cylindrical arm.

The first retractable arm 110 may include a first section 111, a second section 112, and a first extension rod 113, but is not limited thereto.

The first section 111 may have an elongate shape. Moreover, the first section 111 may have a semi-cylindrical shape. The first section 111 may be disposed at a first end on at least a portion of a vehicle connector 20.

The second section 112 may be movably (i.e., slidably) disposed at a first end on at least a portion of a second end of the first section 111. More specifically, the second section 112 may move from extended away from the first section 111 to retracted against and/or within the first section 111 in a first lateral direction. Conversely, the second section 112 may move from retracted against and/or within the first section 111 to at least partially extended away from the first section 111 in a second lateral direction opposite with respect to the first lateral direction.

Alternatively, the second section 112 may move (i.e., rotate, pivot) in any direction with respect to the first section 112. Therefore, the second section 112 may fold and/or rotate angularly, vertically, and/or laterally as desired by a user. Also, the second section 112 may move in response to an application of force (e.g., pushing, pulling) thereto.

Furthermore, the second section 112 may be connected at a second end to a vehicle mirror 10. As such, the vehicle mirror 10 may move in response to movement of the second section 112.

The first extension rod 113 may be disposed within at least a portion of the first section 111 and/or the second section 112. The first extension rod 113 may facilitate movement of the second section 112 with respect to the first section 111. Also, the first extension rod 113 may be exposed in response to the second section 112 being at least partially extended away from the first section 111.

The second retractable arm 120 may include a first section 121, a second section 122, and a second extension rod 123, but is not limited thereto.

The first section 121 may have an elongate shape. Moreover, the first section 121 may have a semi-cylindrical shape. The first section 121 may be disposed at a first end on at least a portion of the vehicle connector 20.

The second section 122 may be movably (i.e., slidably) disposed at a first end on at least a portion of a second end of the first section 121. More specifically, the second section 122 may move from extended away from the first section 121 to retracted against and/or within the first section 121 in a first lateral direction. Conversely, the second section 122 may move from retracted against and/or within the first section 121 to at least partially extended away from the first section 121 in a second lateral direction opposite with respect to the first lateral direction.

Alternatively, the second section 122 may move (i.e., rotate, pivot) in any direction with respect to the first section 122. Therefore, the second section 122 may fold and/or rotate angularly, vertically, and/or laterally as desired by a user. Also, the second section 122 may move in response to an application of force (e.g., pushing, pulling) thereto.

Furthermore, the second section 122 may be connected at a second end to a vehicle mirror 10. As such, the vehicle mirror 10 may move in response to movement of the second section 122.

The second extension rod 123 may be disposed within at least a portion of the first section 121 and/or the second section 122. The second extension rod 123 may facilitate movement of the second section 122 with respect to the first section 121. Also, the second extension rod 123 may be exposed in response to the second section 122 being at least partially extended away from the first section 121.

The first retractable arm 110 and/or the second retractable arm 120 may move simultaneously and/or independently based on a type of movement, such as pivoting, retracting, rotating, folding, etc.

The motor 130 may be movably (i.e., rotatably) disposed on at least a portion of the first section 111 of the first retractable arm 110 and/or the first section 121 of the second retractable arm 120. Moreover, the motor 130 may be connected to the first extension rod 113 and/or the second extension rod 123. As such, the first extension rod 113 and/or the second extension rod 123 may move (e.g., telescopically) the second section 112 and/or the second section 122 in response to movement of the motor 130.

Additionally, the motor 130 may be accessed through the space between the first retractable arm 110 and/or the second retractable arm 120.

The control button 140 may be disposed within the vehicle and/or connected (e.g., physically, electrically) to at least a portion of the motor 130. The motor 130 may move in response to depressing the control button 140. Thus, the second section 112 may retract against and/or within the first section 111 and/or the second section 122 may retract against and/or within the first section 121 in response to depressing the control button 140. However, the second section 112 may at least partially extend away from first section 111 and/or the second section 122 may at least partially extend away from the first section 121 in response to an application of force. In other words, manual force (e.g., external application of force) is required to extend the first retractable arm 110 and/or the second retractable arm 120 in absence of movement of the motor 130.

Alternatively, the motor 130 may extend the first retractable arm 110 and/or the second retractable arm 120 in response to depressing the control button 140 another time based on configuration thereof.

Therefore, the retractable vehicle mirror support device 100 may adjust a length of the vehicle mirror 10 as disposed on a vehicle. Also, the retractable vehicle mirror support device 100 may facilitate storage of the vehicle in a parking space with limited size due to the ability to reduce length of the vehicle mirror 10, such as on a truck, a bus, and/or an RV.

The present general inventive concept may include a retractable vehicle mirror support device 100, including a first retractable arm 110 disposed on at least a portion of a vehicle connector 20 and connected to a vehicle mirror 10 to move the vehicle mirror 10 from extended away from the vehicle connector 20 to retracted toward the vehicle connector 20 in a first lateral direction, and a second retractable arm 120 disposed on at least a portion of the vehicle connector 20 and connected to the vehicle mirror 10 to move the vehicle mirror 10 from extended away from the vehicle connector 20 to retracted toward the vehicle connector 20 in the first lateral direction, such that the second retractable arm 120 is separate and distanced away from the first retractable arm 110.

The first retractable arm 110 and the second retractable arm 120 may each include a first section 111/121 disposed on at least a portion of the vehicle connector 20, and a second section 112/122 movably disposed on at least a portion of the first section 111/121 to move from extended away from the first section 111/121 to retracted within the first section 111/121 in a first lateral direction.

The second section 112/122 may move by at least one of folding, rotating angularly, rotating vertically, and rotating laterally.

The first retractable arm 110 and the second retractable arm 120 may each further include an extension rod 113/123 disposed within at least a portion of the first section 111/121 and the second section 112/122 to facilitate movement of the second section 112/122 with respect to the first section 111/121.

The retractable vehicle mirror support device 100 may further include a motor 130 movably disposed on at least a portion of the first retractable arm 110 and the second retractable arm 120 to move the first retractable arm 110 and the second retractable arm 120 in response to movement of the motor 130.

The motor 130 may move the first retractable arm 110 and the second retractable arm 120 from extended to retracted in the first lateral direction, and the first retractable arm 110 and the second retractable arm 120 move from retracted to at least partially extended in a second lateral direction in response to an external application of force.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A retractable vehicle mirror support device, comprising:
a first retractable arm disposed on at least a portion of a vehicle connector and connected to a vehicle mirror to move the vehicle mirror from extended away from the vehicle connector to retracted toward the vehicle connector in a first lateral direction; and
a second retractable arm disposed on at least a portion of the vehicle connector and connected to the vehicle mirror to move the vehicle mirror from extended away from the vehicle connector to retracted toward the vehicle connector in the first lateral direction, such that the second retractable arm is separate and distanced away from the first retractable arm.

2. The retractable vehicle mirror support device of claim 1, wherein the first retractable arm and the second retractable arm each comprise:
a first section disposed on at least a portion of the vehicle connector; and
a second section movably disposed on at least a portion of the first section to move from extended away from the first section to retracted within the first section in a first lateral direction.

3. The retractable vehicle mirror support device of claim 2, wherein the second section moves by at least one of folding, rotating angularly, rotating vertically, and rotating laterally.

4. The retractable vehicle mirror support device of claim 2, wherein the first retractable arm and the second retractable arm each further comprise:
an extension rod disposed within at least a portion of the first section and the second section to facilitate movement of the second section with respect to the first section.

5. The retractable vehicle mirror support device of claim 1, further comprising:
a motor movably disposed on at least a portion of the first retractable arm and the second retractable arm to move the first retractable arm and the second retractable arm in response to movement of the motor.

6. The retractable vehicle mirror support device of claim 5, wherein the motor moves the first retractable arm and the second retractable arm from extended to retracted in the first lateral direction, and the first retractable arm and the second retractable arm move from retracted to at least partially extended in a second lateral direction in response to an external application of force.
